(19) United States
(12) Patent Application Publication
(10) Pub. No.: US 2016/0078503 A1
(43) Pub. Date: Mar. 17, 2016

(54) METHOD AND APPARATUS TO EXTEND GRACE PERIOD FOR UTILITY PAYMENTS BY PREPAID DEVICE-HOLDERS

(71) Applicant: MASTERCARD INTERNATIONAL INCORPORATED, Purchase, NY (US)

(72) Inventor: Der Pei Wang, Scarsdale, NY (US)

(73) Assignee: MASTERCARD INTERNATIONAL INCORPORATED, Purchase, NY (US)

(21) Appl. No.: 14/484,992

(22) Filed: Sep. 12, 2014

(51) Int. Cl. G06Q 30/04

(52) U.S. Cl. CPC G06Q 30/04

(57) ABSTRACT

Systems and methods for determining whether to extend a grace period to a consumer instead of cancelling their services are described. The system/method accesses payroll card and/or other information pertaining to the consumer's financial and/or employment status and history. Using the information, a score may be determined and used to assess whether to grant the consumer an extension to a grace period and/or to continue access to a utility/service.

### FIELD OF TECHNOLOGY

The present disclosure relates generally to electronic commerce, and more particularly to payment devices for use with electronic payment systems.

### BACKGROUND

Due to misalignment of payments and expenses (e.g. pay check comes sometime after bills for household or other expenses), some consumers may not have immediate access to funds needed to account for the entirety of their expenses. Expenses generally include recurring expenditures, such as utility bills including, phone, cable, gas, electric, heat, and the like. Thus, consumers may generally have to borrow money in order to ensure these expenses are taken care of Typically, when a consumer is unable to meet their payment obligation of a recurring expenditure, the consumer will usually receive a grace period to pay the expenditure. But ultimately, there is a time where the consumer must pay the creditor/utility in order to evade their services being cut off or terminated.

Termination of a service is inconvenient for both the consumer as well as the creditor shutting off the service/utility. The consumer must encounter not having access to services traditionally used on a daily basis until their debt to the creditor is satisfied. Likewise, the creditor encounters difficulties by having to turn the consumer's account into collections, and when the consumer eventually pays the debt, having to put the consumer back on the service.

This cycle of termination and re-activation of the services may, for example, occur due to a creditor's bill being due and the consumer not having the money to pay until several days after the bill's due date and any grace period. Currently, creditors have no way of distinguishing between an unreliable consumer and one who would pay but merely does not have sufficient funds until after their bill is due. In some instances a consumer would benefit from receiving an extension of any grace period in order to avoid unnecessary termination of service.

Presently in cases where there is a misalignment between income and expenses, so called “pay day loans” may be used to solve the timing issue. However, such loans can be very costly and otherwise create issues for consumers who come to rely on them.

### SUMMARY

The present disclosure describes systems and methods for creditors to determine whether to extend a grace period to a consumer instead of cancelling/terminating their services. Via an automated system, the creditor may receive and benefit from use of more detailed information about the consumer, such as information specific to the consumer's salary, pay timing, payment and credit history. The creditor may also use information such as past and present employment information of the consumer. Such information may be beneficial to the creditor if for example the consumer has minimal to no credit history.

Information and benefits associated with “payroll cards” or similar devices may be used in the automated system to defer termination (e.g. extend a grace period before cutting off service) of a utility (phone, cable, gas, electric, heat, internet service and the like). With payroll cards or devices, used by employers as an alternative to payroll checks, employee's pay information (salary) is posted to an account tied to the employees payroll card or device (it should be appreciated that the terms “card” and device” are used interchangeably herein and indicate that the payroll mechanism may be other than a physical card but may be a device, such as a handheld or other electronic device that implements similar or the same functionality as a physical payroll card). Once an employee's salary/pay is loaded to their personal account/card they can have immediate access to the funds, however, the account includes information that may be used to determine/assess whether a consumer, late with a payment due on a utility, is a suitable candidate for extension of a grace period or continuation of the utility service despite not having made a timely payment.

In an illustrative system and method according to the disclosure a consumer has a payroll or GPR card and associated account into which they receive or have deposited wages from their employer(s) and from which the consumer is able to make payments using the received wages. Consumer information obtained from the payroll card account includes, some or more information such as payroll data, employment duration and salary, timing and frequency of received wages or deposits, accrued wages, amount of the consumer's upcoming received wages, past transactions utilizing the payroll or GPR card, past records of deposit from employers. The system and method analyzes, whether the account receives wages at regular intervals (an indication of whether the consumer is employed), timing and amount of any expected next payment (may be based on extrapolation of past payments), and payment or expense history of using the payroll or GPR card/device account. The automated system/method determines a score relating to the consumer's reliability to pay the expenditure if they receive a grace period, i.e., predict the likelihood the consumer will pay the outstanding expenditure in the next “X” amount of days. Upon generation of the score, a determination is then made as to whether the consumer is qualified for a grace period. If it is assessed that the consumer is not qualified for a grace period, the automated system may provide an indication that the creditor should terminate 310 the services provided to the consumer, and/or terminate any contract with the consumer. If, however, the system/method determines the consumer is qualified to receive a grace period, the creditor may extend such a grace period to the consumer. The length of extension may also be determined. For example the length of extension may be determined depending on whether the score falls within specified ranges such as may be stored in a table and modified from time to time). The length of this grace period may be automatically determined as a function of parameters considered during scoring. An automated message or other communication may be generated to inform the consumer that the grace period is or is not granted, and if granted the length of the grace period may be communicated. For example, an automatic notice letter, email, or text or the like may be generated indicating the foregoing.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a block diagram detailing an illustrative embodiment of the disclosure.

FIG. 2A is an overview block diagram of an illustrative embodiment of the disclosure.

FIG. 2B is a block diagram detailing an illustrative embodiment of the disclosure.

FIG. 3 is a flow diagram detailing an illustrative embodiment of the disclosure.

### DETAILED DESCRIPTION

The detailed description of aspects of the present disclosure set forth herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to singular embodiment may include plural embodiments, and references to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

The terms “device,” “card,” “payroll card” and “payment card” are used interchangeably herein to describe a card or device that can be presented by the account holder to make a payment or that can be used to make a payment in a remote transaction, such as an e-commerce transaction, telephone transaction, or mail order for example. The remote transactions such as e-commerce transactions, telephone transactions and mail order transactions, in which the card is not presented directly to a merchant during the transaction, are referred to herein as card-not-present (“CNP”) transactions. Payment cards may also include pre-paid cards such as payroll cards or general purpose reloadable cards (collectively referred to herein as “payroll cards”). Payroll cards generally provide a mechanism to pay employees efficiently as an alternative to issuing payroll checks, and may be used in contexts where the employee does not have a regular relationship with a banking institution such as a savings account, checking account, credit or debit card account.

Generally, physical payment cards have a “front” and a “back” and the card back usually has at least a bar code or a magnetic stripe that contains account information, and a signature panel. The card front generally has the payment brand, an issuer brand, an account number, cardholder name, expiration date, and certain security features (such as a hologram).

A magnetic stripe card is a type of card capable of storing data by modifying the magnetism of iron-based magnetic particles on a band of magnetic material on the card. The magnetic stripe, also referred to herein as a mag stripe, is read by physical contact and swiping past a reading head.

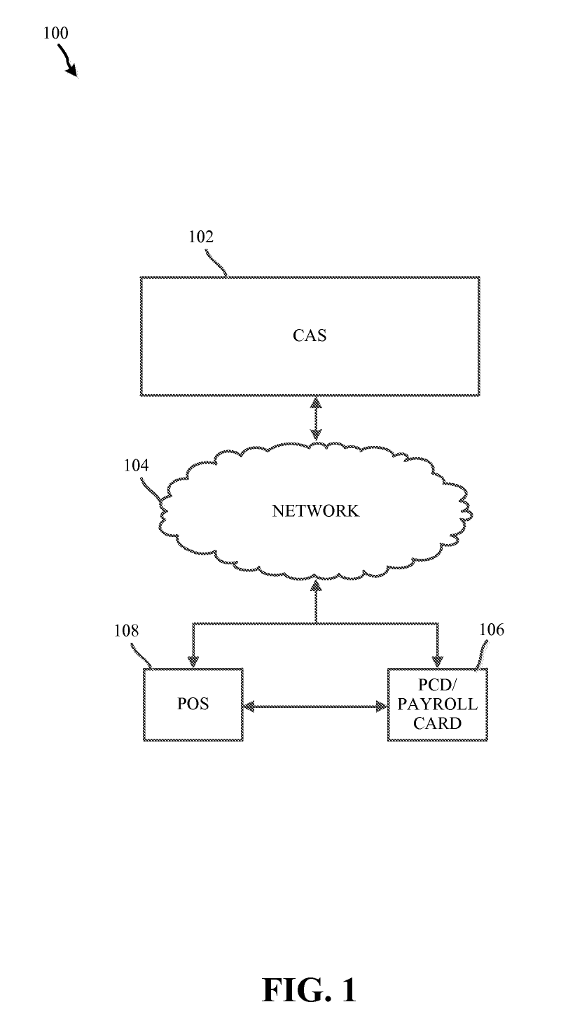

Referring to FIG. 1, a system 100 for processing payments is illustrated according to various embodiments of the disclosure. The system 100 may comprise a Card Authorization System (“CAS”) 102 for receiving transaction information and facilitating the transaction, a Network 104 for communication to/from the CAS 102, a Portable Consumer Device (“PCD”) (such as a payroll card or electronic device) 106 for a user/customer to effect the transaction, and a merchant Point of Sale device (“POS”) 108 which represents the situs at which the transaction is initiated. The various system components may communicate via the Network 104 or multiple networks may be implemented and in communication.

In various embodiments, the CAS 102 (also known as an account authorization system) may be capable of or configured to perform all or part of an authorization process in relation to a payment transaction associated with a transaction account. The CAS 102 may comprise any combination of hardware and software, such as servers, databases, firewalls, computers, etc., in order to authorize transactions. In various embodiments, the CAS 102 may be operated by a payment processor (e.g., transaction account issuer).

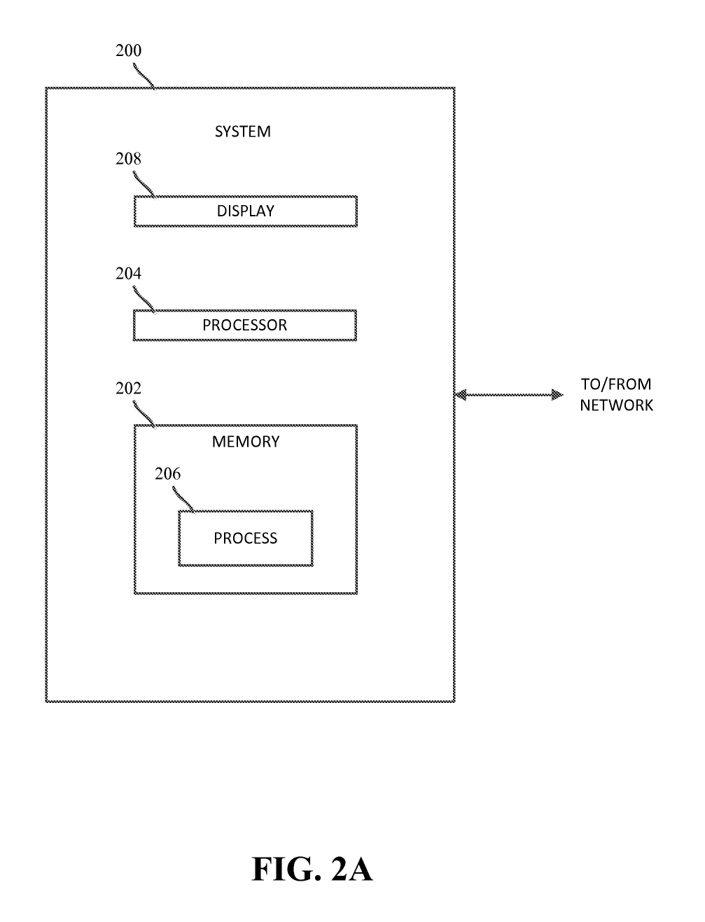

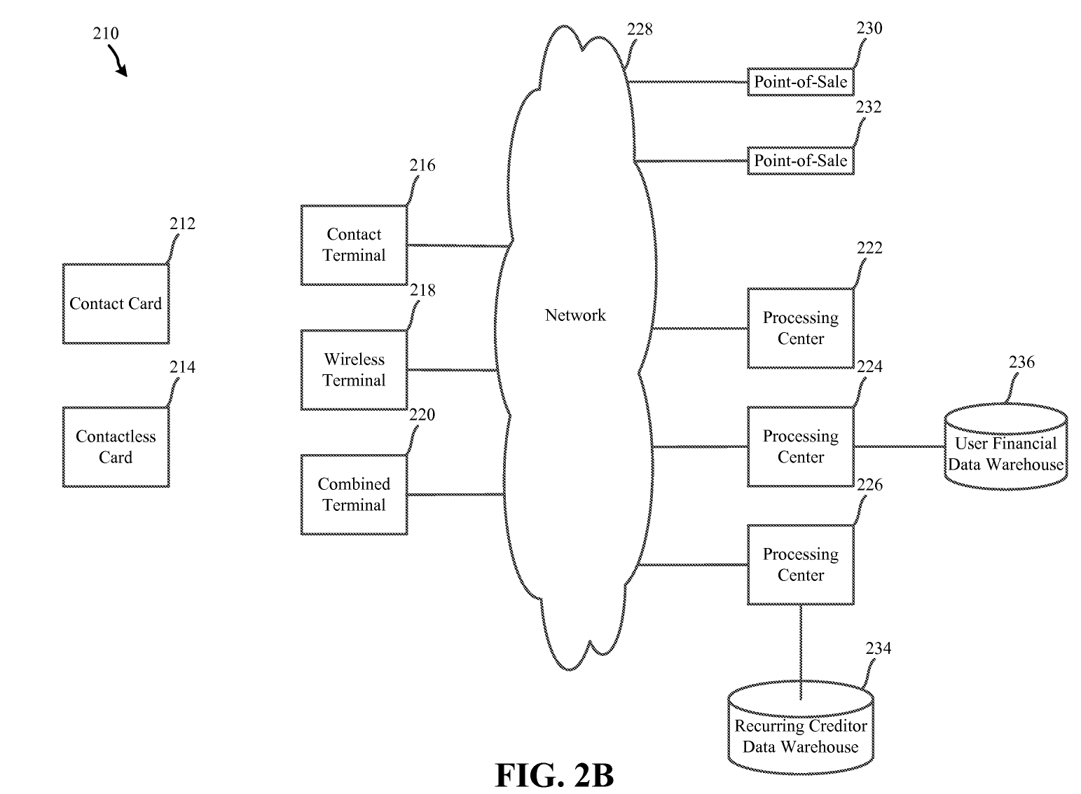

FIG. 2A is a block diagram of a system 200 that can implement part or all of one or more aspects or processes of systems within which payroll cards according to embodiments of the present disclosure can operate or within which methods according to embodiments of the present disclosure can be carried out. As shown in FIG. 2A, a memory 202 includes instructions to configure a processor 204 to implement one or more aspects of the methods, steps, and functions disclosed herein (collectively, shown as process 206 in FIG. 2A). Different method steps may be performed by different processors. The memory 202 could be distributed or local and the processor 204 could be distributed or singular. The memory 202 could be implemented as an electrical, magnetic or optical memory, or any combination of these or other types of storage devices. It should be noted that if distributed processors are employed, each distributed processor that makes up the processor 204 generally contains its own addressable memory space. It should also be noted that some or all of the computer system 200 can be incorporated into an application-specific or general-use integrated circuit. For example, one or more method steps could be implemented in hardware in an ASIC rather than using firmware. A display 208 is representative of a variety of possible input/output devices (e.g., displays, mice, keyboards, and so on).

Attention should now be given to FIG. 2B, which depicts a non-limiting example of a system 210, within which payroll cards according to embodiments of the present disclosure could be used, and/or within which exemplary methods according to embodiments of the present disclosure could be carried out. Various possible components of the system are shown. A system 210 can include one or more different types of portable payment devices or payroll cards. For example, one such device can be a contact card 212. The contact card 212 can include an integrated circuit (IC) chip having a processor portion and a memory portion. A plurality of electrical contacts can be provided for communication purposes.

In addition to or instead of the contact card 212, the system 210 can also be designed to work with a contactless card 214. The contactless card 214 can include an IC chip having a processor portion and a memory portion. An antenna can be provided for contactless communication, such as, for example, using radio frequency (RF) electromagnetic waves. An oscillator or oscillators, and/or additional appropriate circuitry for one or more of modulation, demodulation, down conversion, and the like can be provided. Other types of devices could include a card 232 having a magnetic stripe 234.

The ICs of both the contact and contactless cards 212, 214 can contain their respective processing units and memory units. The ICs can also include one or more of control logic, a timer, and input/output ports. Such elements are well known in the IC art and are not separately illustrated. One or both of the ICs can also include a co-processor, again, well-known and not separately illustrated. The control logic can provide, in conjunction with the processing units, the control necessary to handle communications between the memory unit and the input/output ports. The timer can provide a timing reference signal from the processing units and the control logic. The co-processor could provide the ability to perform complex computations in real time, such as those required by cryptographic algorithms.

The memory portions of both the contact and contactless cards 212, 214 may include different types of memory, such as volatile and non-volatile memory and read-only and programmable memory. The memory units can store transaction card data such as, e.g., a user's personal identification number (“PIN”) and/or primary account number (“PAN”). The memory portions can store the operating system of the cards 212, 214. The operating system loads and executes applications and provides file management or other basic card services to the applications. One operating system that can be used is the MULTOS® operating system licensed by MAOSCO Limited. (MAOSCO Limited. St. Andrews House, The Links, Kelvin Close, Birchwood, Warrington, WA3 7PB. United Kingdom). Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. The operating system may be stored in read-only memory (“ROM”) within the memory portion. Flash memory or other non-volatile and/or volatile types of memory may also be used in the memory units.

In addition to the basic services provided by the operating system, the memory portions may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the card can be configured to conform to such EMV-compliant terminal behavior and in this sense is itself EMV-compliant. It will be appreciated that applications can be configured in a variety of different ways.

As noted, the cards 212, 214 are examples of a variety of payment devices. Devices could include cards having a conventional form factor, smaller or larger cards, cards of different shape, key fobs, and the like. The cards can include body portions (e.g., laminated plastic layers of a payment card, chip packaging, and the like), the memories associated with the body portions, and the processors associated with the body portions and coupled to the memories. The memories can contain appropriate applications. The processors can be operative to execute one or more method steps. The applications can be, for example, application identifiers (AIDs) linked to software code in the form of firmware plus data in a card memory such as an electrically erasable programmable read-only memory (EEPROM). It should be appreciated that “smart” cards are not necessarily required and a conventional magnetic stripe card can be employed. The “cards” may not be physical cards in the conventional sense, but rather may be handheld or other electronic devices that provide the same or similar functionality as described herein.

Note that it is presently prevalent to employ full-sized cards of a conventional form factor in order to have sufficient space to include the acceptance attributes on a single side. Cards may conform to the ISO/IEC 7810 ID-1 format for example (also referred to as “full sized” or “conventional form factor.”

A number of different types of terminals can be employed with the system 210. Such terminals can include a contact terminal 216 configured to interface with the contact-type device 212, through means such as a magnetic stripe terminal, a wireless terminal 218 configured to interface with wireless device 214, or a combined terminal 220. The combined terminal 220 is designed to interface with both the contact device 212 as well as the contactless device 214. Some terminals can be contact terminals with plug-in contactless readers. The combined terminal 220 can include a memory, a processor portion, a reader module, and optionally an item interface module such as a bar code scanner and/or a radio frequency identification (RFID) tag reader. The memory, reader module, bar code scanner, and RFID tag reader can be coupled to the processor. Note that the principles of construction of the combined terminal 220 are applicable to other types of terminals and are described in detail for illustrative purposes. The reader module can be configured for contact communication with the contact card or device 212, through means such as a magnetic stripe, contactless communication with the contactless card or device 214, or a combination of any two or more of the foregoing (different types of readers can be provided to interact with different types of cards). The terminals 216, 218, 220 can be connected to one or more processing centers 222, 224, 226 via a computer network 228. The network 228 could include, for example, the Internet, or a proprietary network. More than one network could be employed to connect different elements of the system. The processing centers 222, 224, 226 can include, for example, a host computer of an issuer of a payment device.

Many different retail or other establishments, represented by the points-of-sale 230, 232 can be connected to the network 228. In one or more instances, various establishments may interface with a telecommunications network, such as a virtual private network (VPN), via one or more machines which are then connected to the network. Each such establishment can have one or more terminals.

Portable payment devices can be used to facilitate transactions by a user with a terminal, such as the contact terminal 216, wireless terminal 218, and combined terminal 220, of a system such as the system 210. Such devices can include a processor, for example, the processing units discussed above. The device can also include a memory, such as the memory portions discussed above, that is coupled to the processor. Further, the device can include a communications module that is coupled to the processor and configured to interface with a terminal such as one of the contact, wireless, and combined terminals 216, 218, 220. The communications module can include, for example, the contacts or antennas together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

It will be appreciated that the contact, wireless, and combined terminals 216, 218, 220 are examples of terminal apparatuses for interacting with a payment device 212, 214 of a holder. The apparatus can include a processor, a memory that is coupled to the processor, and a communications module such as a reader module that is coupled to the processor and configured to interface with the portable apparatuses. The processor can be operable to communicate with portable payment devices 212, 214 of a user via the communications module. The terminal apparatuses can function via hardware techniques in the processor, or by program instructions stored in the memory. Such logic could optionally be provided from a central location such as the processing center 222 over the network 228. The aforementioned bar code scanner and/or RFID tag reader can be provided, and can be coupled to a processor, to gather attribute data, such as a product identification, from a UPC code or RFID tag on a product to be purchased.

The above-described devices 212, 224 can be ISO 7816-compliant contact cards or devices or NFC (Near Field Communications) or ISO 14443-compliant proximity cards or devices. In operation, card 212 can be swiped on the contact terminal 216, or can be touched or tapped on the wireless or combined terminals 218, 220, which then contactlessly transmits the electronic data to the proximity IC chip in the card 212 or other wireless device.

One or more of the processing centers 222, 224, 226 can include a database such as a recurring creditor data warehouse 234 or user financial data warehouse 236. The recurring creditor data warehouse 234 may contain information regarding, for example, consumer contracts and durations, and bill timings and prices. The user financial data warehouse 268 may include information pertaining to a consumer, such as payroll history and frequency, credit history and score, outstanding balances, available remaining line of credit or accrued wages on the consumer's payroll card, employment status and duration, and salary. The processing centers 222, 224, 226 may be operably connected in order to share information. For example, the processing centers 224, 226 may be connected to allow the interchange of information contained within the data warehouses 234, 236.

Cards in accordance with embodiments of the present disclosure may be used within larger systems that can employ hardware and/or software aspects. Software includes but is not limited to firmware, resident software, microcode, etc. Software might be employed, for example, in connection with a terminal 216, 218, 220; a processing center having or optionally with a wired or wireless connection to data warehouses 234, 236) of a recurring creditor, issuer, acquirer, processor, or operator of a network operating according to a payment system standard (and/or specification); and the like. Firmware might be employed, for example, in connection with payment devices such as cards 212, 214.

Thus, elements of a system can make use of computer technology with appropriate instructions to facilitate method steps. By way of further example, a terminal apparatus 216, 218, 220 could include, inter alia, a communications module, an antenna coupled to the communications module, a memory, and at least one processor coupled to the memory and the communications module and operative to integrate a contactless payment device (in lieu of the antenna and communications module, appropriate contacts and other elements could be provided to interrogate a contact payment device such as a contact card or read a magnetic stripe).

An electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

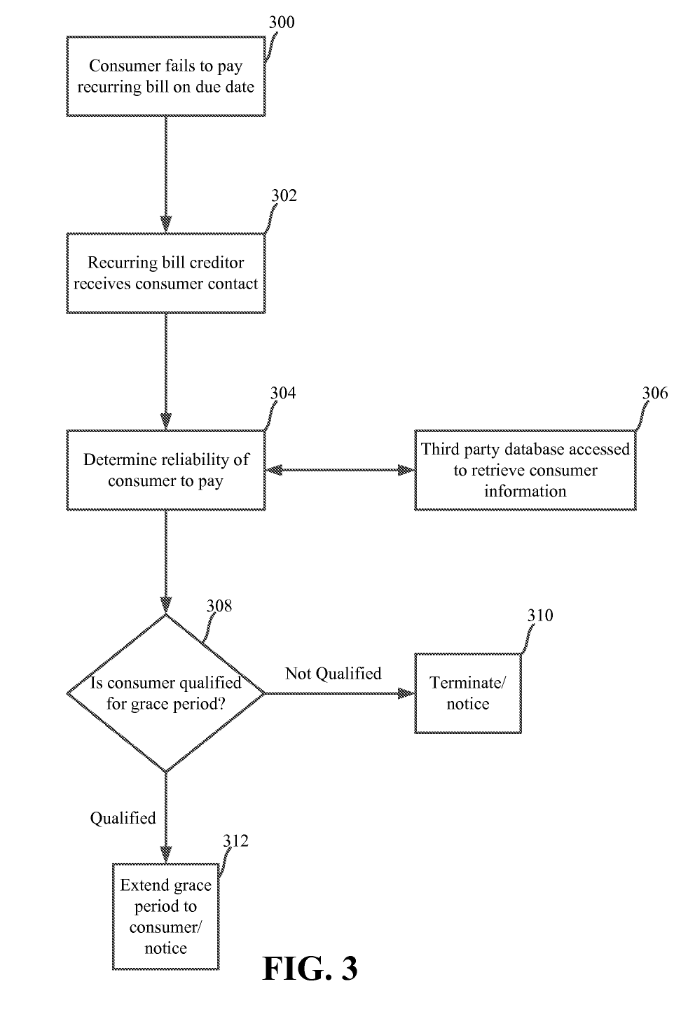

Referring now to FIG. 3, a method according to various embodiments of the present disclosure implementing a system and method for determining whether and how long to extend a grace period to a consumer are described. At the outset, the consumer fails to pay their recurring expenditure on its due date, 300. According to an embodiment, a contacting step 302 takes place wherein the consumer contacts the creditor of the overdue expenditure, and the creditor of the recurring expense for which the consumer is billed receives contact from the creditor. Such contact may transpire according to any appropriate means of communication. In an exemplary embodiment, the consumer authorizes a future debit transaction from their card to cover all or a portion of the overdue expenditure. This authorization can be for a specific day in the future of can be a general authorization for any day in the future the creditor determines is appropriate. For example, the consumer can request the payment for the overdue expenditure be authorized for the consumer's next payday. The contact from the consumer may be received at an automated or computerized system as described herein or it may be received by a human operator and the contact and associated contact information inputted to the automated system by the human operator. Alternatively, the consumer may directly input information relating to the contact to the automated system.

In an illustrative embodiment, a third party database or data warehouse may be accessed to retrieve information pertaining to the consumer. The third party data warehouse accessed in the accessing step 306 may be, for example, a card issuer of a payroll card that maintains information relating to the consumer's payroll card account. The accessing step 306 may occur at any point, and is not limited to occurring after the contacting step 302. The information retrieved by the creditor may be account information specific to the payroll card the consumer owns including, for example, the card authorized for the future transaction in the contacting step 302. Alternatively, card information may be retrieved relating to a general purpose reloadable (“GPR”) card owned by the consumer. Further, the information retrieved may include, for example, employment status and duration, payroll history and frequency, accrued pay, credit history and score, outstanding balances, and any available remaining line of credit on the consumer's card.

In an exemplary embodiment, the consumer has a payroll or GPR card upon which they receive or have deposited wages from their employer(s) and from which the consumer is able to make payments using the received wages. According to this exemplary embodiment, the consumer information obtained from the third party, such as the card's issuer, may include, in addition to the above information, payroll data such as employment duration and salary, timing and frequency of received wages or deposits, accrued wages, amount of the consumer's upcoming received wages, past transactions utilizing the payroll or GPR card, as well as past records of deposit from employers. Information pertaining to the past transactions utilizing the payroll or GPR card may include the frequency of the transactions, which vendors are involved in the transactions, as well as the amount of the transactions. In this context, one way the creditor is able to determine whether the consumer is employed is by analyzing whether the card receives wages at regular intervals and in comparative amount. In another exemplary embodiment, the creditor may conduct this analysis by directly accessing other third party database or data warehouse financial information, such as the consumer's bank account(s).

Upon completion of the accessing step 306, the automated system engages in a determining step 304 wherein, for example, a score may be generated relating to the consumer's reliability to pay the expenditure if they receive a grace period, i.e., predict the likelihood the consumer will pay the outstanding expenditure in the next “X” amount of days. Payment profiling may also be done to predict the likelihood the consumer will pay. If a score is generated, the score may be generated using one or more scoring models including, but not limited to, a statistical scoring model or a judgmental scoring model. A statistical or judgmental or other scoring model may correlate multiple factors from one or more parameters relating to the consumer's likelihood to pay, such as whether the consumer is employed, timing and amount of the next wage payment, and payment history of using the payroll card. Weights may be assigned to each factor.

A judgmental scoring model may be used and take into consideration additional factors such as the consumer's financial statement, payment history, bank references, and the expenditure creditor's previous experience with the consumer. Further, the score may be generated using the consumer information obtained from further third party information separately or in combination to information already known to the creditor, such as the consumer's past payment history with the creditor.

Upon generation of the score, a determination is then made 308 as to whether the consumer is qualified for a grace period. For illustration, the creditor may not grant a grace period unless the generated score meets or exceeds a certain minimum threshold. Alternatively, scores may be determined and the applicability of granting a grace period may be assessed on a case-by-case/score-by-score basis. If it is assessed that the consumer is not qualified for a grace period, the automated system may provide an indication that the creditor should terminate 310 the services provided to the consumer, and/or terminate any contract with the consumer.

If, however, the creditor determines the consumer is qualified to receive a grace period, the creditor may extend 312 such a grace period to the consumer. The length of extension may also be determined. For example the length of extension may be determined depending on whether the score falls within specified ranges such as may be stored in a table and modified from time to time). The length of this grace period may be automatically determined as a function of parameters considered during scoring 304, or may be determined according to or in conjunction with a request/suggestion by the consumer made during the contacting step 302. Thus the length of the grace period may be determined as a function of the score generated for the consumer. Alternatively, the length may be determined according to the consumer's future receipts of wages. In granting a grace period, the creditor may establish a payment schedule rather than requiring the entirety of the overdue balance be due at one time. In any event, an automated message or other communication may be generated to inform the consumer that the grace period is or is not granted, and if granted the length of the grace period may be communicated. For example, an automatic notice letter, email, or text or the like may be generated indicating the foregoing.

The computer systems and servers described herein each contain a memory that will configure associated processors to implement methods, steps, and functions described. Such methods, steps, and functions can be carried out, e.g., by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more aspects of a system can include a computer program comprising computer program code means adapted to perform one or more steps described when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (an exemplary and non-limiting list), and can also make use of, for example, Extensible Markup Language (XML), known application programs such as relational database applications, spreadsheets, and the like. The computers can be programmed to implement the methods, steps and logic described.

As described herein a network may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse, combinations thereof and/or any suitable communication or data input modality.

Various databases used herein may include: consumer data; creditor data; third party institution data; and/or like data useful in the operation of the system. As those skilled in the art will appreciate, the consumer may use a computer in the method described and the user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as assessing, determining, matching or selecting, which are commonly associated with mental operations performed by a human operator. No such capability of a human operator is necessary, or desirable in most cases, in any of the operations described herein. Rather, the operations may be machine operations. After reading this description, it will become apparent to a person skilled in the relevant art(s) how to implement various embodiments using other computer systems and/or architectures.

Any such computer system also includes a main memory, such as for example random access memory (RAM), and may also include a secondary memory or a removable storage unit. Removable storage unit represents a floppy disk, magnetic tape, optical disk, etc. which is read by and written to by removable storage drive. As will be appreciated, the removable storage unit includes a computer usable storage medium having stored therein computer software and/or data.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, software may be implemented in hardware components such as application specific integrated circuits (ASICs). Implementation of a hardware state machine to perform the functions described herein will be apparent to persons skilled in the relevant art(s).

Databases or data warehouses discussed herein may include relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art.

The computers discussed herein may provide a suitable website or other Internet-based graphical user interface which is accessible by users.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, steps described and the descriptions thereof may comprise configurations of and make reference to user windows, pop-up windows, webpages, websites, web forms, prompts, or the like.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. It should be appreciated that in the appended claims, reference to an element in the singular is not intended to mean “one and only one” unless explicitly so stated, but rather “one or more.”

Although illustrative embodiments of the present disclosure have been described herein with reference to the accompanying drawings, it is to be understood that the present disclosure is not limited to those precise embodiments, and that various other changes and modifications may be made by one skilled in the art without departing from the scope or spirit of the disclosure.

What is claimed is:

1. A computer implemented method of determining whether to grant a consumer continuation of a utility, the method comprising the steps of:
accessing, using the computer, a payroll device account of the consumer;
determining, using the computer system, a score relating to the consumer's reliability to pay an expenditure relating to continuation of the utility;
assessing, using the computer system, whether the consumer is qualified for continuation of the utility, based on the score; and
providing an indication of at least one of the consumer is qualified for continuation of the utility or the consumer is not qualified for continuation of the utility.

2. The computer implemented method of claim 1 further comprising the step of generating a notice to the consumer indicating whether the consumer is or is not qualified for continuation of the utility.

3. The computer implemented method of claim 1 further comprising the step of determining a length of a period of continuation of the utility.

4. The computer implemented method of claim 3 wherein the length of the period of continuation of the utility is determined based on whether the score falls within specified ranges.

5. The computer implemented method of claim 1 wherein the step of assessing, using the computer system, whether the consumer is qualified for continuation of the utility, based on the score involves determining whether a grace period for continuation of the utility should be extended.

6. The computer implemented method of claim 5 wherein a length of extension of the grace period is automatically determined as a function of parameters considered during scoring.

7. The computer implemented method of claim 1 wherein the step of determining the score relating to the consumer's reliability to pay an expenditure relating to continuation of the utility involves scoring based on at least one of payroll data, employment duration and salary, timing and frequency of received wages, timing and frequency of deposits, accrued wages, amount of consumer's upcoming wages, past transactions utilizing the payroll device, and past records of deposit from employer.

8. The computer implemented method of claim 2 wherein the step of generating a notice to the consumer indicating whether the consumer is or is not qualified for continuation of the utility includes at least one of generating an automatic notice letter, an email, and a text message.

9. A system comprising:
a memory;
at least one processor operatively coupled to the memory; and
a persistent storage device operatively coupled to the memory and storing in a non-transitory manner instructions which when loaded into the memory cause the at least one processor to be operative to:
access a payroll device account of a consumer;
determine a score relating to the consumer's reliability to pay an expenditure relating to continuation of a utility;
assess whether the consumer is qualified for continuation of the utility, based on the score; and
provide an indication of at least one of the consumer is qualified for continuation of the utility or the consumer is not qualified for continuation of the utility.

10. The system of claim 9 further comprising a database accessible by the processor to determine the score relating to the consumer's reliability to pay an expenditure relating to continuation of the utility, the data base storing at least one of payroll data, employment duration data, salary data, data relating to timing and frequency of received wages, data relating to timing and frequency of deposits, accrued wage data, data relating to the consumer's past transactions utilizing the payroll device, and data records of deposit from employer.

11. The system of claim 9 further comprising instructions which when loaded into the memory cause the at least one processor to be operative to generate a notice to the consumer indicating whether the consumer is or is not qualified for continuation of the utility.

12. The system of claim 9 further comprising instructions which when loaded into the memory cause the at least one processor to be operative to determine a length of a period of continuation of the utility.

13. The system of claim 9 further comprising instructions which when loaded into the memory cause the at least one processor to be operative to determine the length of the period of continuation of the utility based on whether the score falls within specified ranges.

14. A computer system configured to determine whether to grant a consumer continuation of a utility, the computer system comprising:
processor means for accessing a payroll card account of the consumer;
processor means for determining a score used in determining whether the consumer is qualified for continuation of the utility, based on the score;
processor means for providing an indication of at least one of the consumer is qualified for continuation of the utility or the consumer is not qualified for continuation of the utility; and
processor means for generating a notice to the consumer indicating whether the consumer is or is not qualified for continuation of the utility.

15. The computer system of claim 14, further comprising a database accessible by the processor means for determining a score, to determine the score relating to whether the consumer is qualified for continuation of the utility, the data base storing at least one of payroll data, employment duration data, salary data, data relating to timing and frequency of received wages, data relating to timing and frequency of deposits, accrued wage data, data relating to the consumer's past transactions utilizing the payroll card, and data records of deposit from employer.

16. The computer system of claim 14, further comprising processor means for determining a length of a period of continuation of the utility.

17. The computer system of claim 14, further comprising processor means for determining length of the period of continuation of the utility based on whether the score falls within specified ranges.

18. The computer system of claim 14, further comprising processor means for determining whether a grace period for continuation of the utility should be extended.
